(19) United States
(12) Patent Application Publication
(10) Pub. No.: US 2015/0118645 A1
(43) Pub. Date: Apr. 30, 2015

(54) APPLICATOR FOR DISPENSING MATERIALS THROUGH A WATER-JET DEVICE

(71) Applicant: Bruno Binyamin Cohen Tanugi, Bnei-Brak (IL)

(72) Inventor: Bruno Binyamin Cohen Tanugi, Bnei-Brak (IL)

(21) Appl. No.: 14/231,334

(22) Filed: Mar. 31, 2014

Related U.S. Application Data
(63) Continuation-in-part of application No. 14/066,178, filed on Oct. 29, 2013.

(51) Int. Cl. A61C 17/02; A61C 19/06

(52) U.S. Cl. CPC A61C 17/0202; A61C 19/063
USPC 433/88

(57) ABSTRACT

An applicator for dispensing materials through a water jet device comprising a dispensing member having an inner cavity therein, the dispensing member comprises a plurality of openings thereover for allowing water and dispensing materials to enter and exit the cavity; and a cover serving as a removable tip of the water jet device, covering the dispensing member such that it forms a space between the cover and the dispensing member in the area of the openings of the dispensing member for containing a dispensing material therein. The applicator is configured for connecting to the water jet device such as to have water jet thereof directed through the cavity of the dispensing member and for dispensing allotted portions of the dispensing materials into the water jet through the openings of the dispensing member. The applicator is also configured for removably connecting to the water jet device for replacing and/or refilling thereof.

### CROSS-REFERENCE TO RELATED PATENT APPLICATIONS

This application is a continuation-in-part (CIP) of U.S. patent application Ser. No. 14/066,178 filed on Oct. 29, 2013, which is incorporated herein by reference in its entirety.

### FIELD OF THE INVENTION

The present invention generally relates to dispensing apparatuses and more particularly to dispensing apparatuses for water jet devices.

### BACKGROUND OF THE INVENTION

Water jet techniques are used for a variety of purposes and a variety of devices such as water jet cutters enabling cutting through rigid materials such as stone or metal or dental water jet devices for dental cleansing.

Dental water jet devices also called oral irrigators are designed for applying water jets over the teeth and gum-line to remove food debris, stains and bacteria (plaque) from the tooth as well as from hard-to-reach areas in the oral cavity such as between dense teeth and between a tooth and its surrounding gums. Oral irrigators are also used to irritate the gums to further improve oral hygiene, tooth and gingival health. The type of the jet (continuous or pulsed) and the jet pressure and thickness determine its efficiency. When using water-jet devices it is often necessary to apply pharmaceutical or cleansing materials over the tooth and gum-line to enhance the operation of the water jet. Using dental water jet devices was proven to improve or even eradicate many dental problems and diseases such as gingivitis which often causes gums to bleed and/or recede, caries and others. Oral irrigators are extremely effective for subjects wearing orthodontic installations such as orthodontic braces.

Oral irrigators often include a spout portion connected to a water pipe, where the diameter of the outlet rim of the spout is significantly small to increase the jet pressure of the water when exiting the spout. The device can connect to a portal and Tillable water container or to a water faucet, depending on the product abilities and purpose.

A patent application publication No. WO2007/147552 A1 discloses an adapter for a mouth spray. The invention is based on the problem of making available a mouth spray that allows water and a treatment agent to be sprayed simultaneously into the mouth. For this purpose, it has already been proposed to install, in the main line to a spray nozzle, a mixing reservoir for admixture of treatment agent to the water. To solve the problem, the invention additionally proposes that the mixing reservoir is located in an adapter, and that the adapter has a first endpiece and a second endpiece, wherein one endpiece of the adapter is designed such that it can be coupled to a handpiece of the mouth spray, and the other endpiece is designed in such a way that it can be coupled to the spray nozzle, as a result of which the main line communicates with the spray nozzle.

### SUMMARY OF THE INVENTION

According to some embodiments of the invention, there is provided an applicator for dispensing materials through a water jet device, wherein the applicator comprises: (a) a dispensing member having an inner cavity therein, the dispensing member comprises a plurality of openings thereover for allowing water and dispensing materials to enter and exit the cavity; and (b) a cover covering the dispensing member in such a manner that it forms a space between the cover and the dispensing member in the area of the openings of the dispensing member for containing a dispensing material therein, wherein the cover is configured as a removable tip of the water jet device. The applicator is configured for connecting to the water jet device such as to have water jet thereof directed through the cavity of the dispensing member, wherein the dispensing material in the space is dispensable through the plurality of openings from the space and into the cavity of the dispensing member such that once a water jet is directed by the water jet device through the cavity of the dispensing member, a portion of the water jet enters this space through the openings and carries along into the cavity allotted portions of the dispensing material during the water jet flow through the cavity, and wherein the applicator is configured for removably connecting to the water jet device as the tip of the water jet device, for replacing and/or refilling thereof.

According to some embodiments, the cover that is configured as the tip of the water jet device, has a first edge that has a narrowing shape for enabling water jet with allotted portions of dispensing material exit therefrom and a second edge that is connectable to a body of the water jet device, wherein the cover is further configured for having the dispensing member inserted therein such that an inner wall of the cover covers the dispensing member to form the space therebetween in which the dispensing material is located.

According to some embodiments, the applicator is configured to removably connect to a body of the water jet device through a connector and an adaptor thereof.

Optionally, the applicator further comprises a removable gel applying member including an elongated member having a plurality of openings thereover, wherein a frontal edge thereof is sealed, wherein the elongated member is configured to be inserted through the applicator's inner cavity, wherein the gel applying member is further configured to connect to a pressable gel container for enabling to insert the gel into the applicator through the elongated member, wherein the sealed edge also seals the first rime of the applicator and thereby forces the pressed gel only through the openings of both the elongated member and the cannular member.

The dispensing material can be at least one of: medical material, cosmetic material, cleansing material or any other known in the art material that is configured for being delivered when mixed with water or any other fluid.

According to some embodiments, the dispensing material is in the form of gel, paste, or powder.

According to some embodiments, the dispensing member has a cannular member over which the openings are disposed, wherein the cannular member edges have rims configured for engaging rims of the cover such as to form the space between the cover and the cannular member for containing the dispensing material therein.

According to other embodiments of the invention, there is provided a water jet device for enabling dispensing materials when using thereof, the water jet device comprises: a jet device body; a connector for connecting the body to a water pipe for receiving water therethrough; and an applicator for economically dispensing of a material therethrough when the water jet is operated. The applicator is configured as a removable and replaceable tip of the body and of the entire water jet device. According to some embodiments, the applicator comprises: (a) a dispensing member comprising a cannular member having an inner cavity therein, and at least one rim connected to the cannular member and protruding therefrom forming a recess thereby over an outer surface of the cannular member, wherein the cannular member comprises a plurality of openings thereover; and (b) a cover having a tip shape covering the cannular member in such a manner that it encloses the recess to form a space between the cover and the cannular member in which the material is located, wherein the space is configured for containing a dispensing material therein to allow dispending the contained material through said plurality of openings into said cavity of the cannular member to enable dispensing allotted portions of the material when a respective water jet is directed towards a respective jet tip of the water jet device during the water jet flow through the cavity, and wherein the applicator is configured for removably connecting to the water jet device for allowing replacing and/or refilling thereof and for allowing using the water jet device without the applicator.

According to some embodiments, the cover of the applicator being configured as the tip of the water jet device, has a first edge that has a narrowing shape for enabling water jet with allotted portions of dispensing material exit therefrom and a second edge that is connectable to a body of the water jet device, wherein the cover is further configured for having the dispensing member inserted therein such that an inner wall of the cover covers the dispensing member to form the space therebetween in which the dispensing material is located.

Optionally, the water jet device is a dental water jet device functioning as an improved oral irrigator device, allowing applying dental materials through the applicator.

According to some embodiments, the water jet device further comprises a valve installed at the jet tip to allow users to open and close the water jet therethrough.

The cover optionally has a curved shape at an outlet edge thereof.

The water jet device optionally further comprises a handle designed for a user to grab on thereto when applying a water jet, said handle comprises a valve mechanism for enabling the respective user to control water flow while holding said handle.

According to some embodiments, the material is at least one of: medical material, cleansing material, cosmetic material and may be in the form of gel, paste, cream or powder.

### BRIEF DESCRIPTION OF THE DRAWINGS

FIG. 1 is an exploded view, schematically showing a dental water jet device including a dispensing apparatus embedded therein, according to some embodiments of the present invention.

FIG. 2 is an exploded view, schematically showing the dispensing apparatus of FIG. 1, according to some embodiments of the present invention.

FIG. 3 is an exploded view, schematically showing a dental water jet device including a dispensing apparatus embedded therein, according to other embodiments of the present invention.

FIG. 4 is a cross sectional view of the dental water jet device of FIG. 3 having the applicator installed therein, according to some embodiments of the present invention.

FIG. 5 is an exploded view schematically illustrating a water jet device, according to other embodiments of the present invention.

FIG. 6A is a cross sectional view schematically illustrating a jet tip of a water jet device having an applicator connected thereto, according to yet another embodiment the present invention.

FIG. 6B shows the jet tip and the applicator of FIG. 6A.

FIG. 7 shows a transparent exploded side view of a jet device system with an applicator configured for being used as a dispensable jet device tip, according to other embodiments of the invention.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention, in some embodiments thereof, provides an applicator that allows dispensing material such as gel, paste, ointment, powder and the like therefrom through a water jet device in a moderated economical manner for dispensing allotted portions of the material during each water jet irrigation-session and during multiple utilizations thereof. The applicator, according to some embodiments, allows dispensing the material during the operation of the water jet device in an efficient manner both economically as well as medically and/or hygienically, by allowing both prolonging the utilization time of a predefined gel portion as well as enabling a substantially continuous emission of the material throughout each irrigation-session.

According to some embodiments of the present invention, the applicator is designed to dispense dental material such as Chlorhexidine gel, Xylitol, toothpaste, or any other dental material whether liquid gel or powder, through a dental water jet device (oral irrigator) for medical/cleansing/cosmetic purposes. Since the gel is dispensed during the dispensing of the water jet the dispensed dental material can be directed along with the water jet to a desired location such as between the tooth and its surrounding gum tissue to enhance the effect of the water jet as well as the effect of the dental material.

According to additional or alternative embodiments of the present invention, there is provided a water jet device including an applicator that is installed therein, where the applicator allows dispensing material therefrom into the water jet of the device in a moderated economical manner for dispensing allotted portions of the gel during each water jet irrigation-session and during multiple utilizations thereof.

The term “irrigation-session” refers to each period in which the water jet device is utilized where a jet of water is outputted from the water jet device.

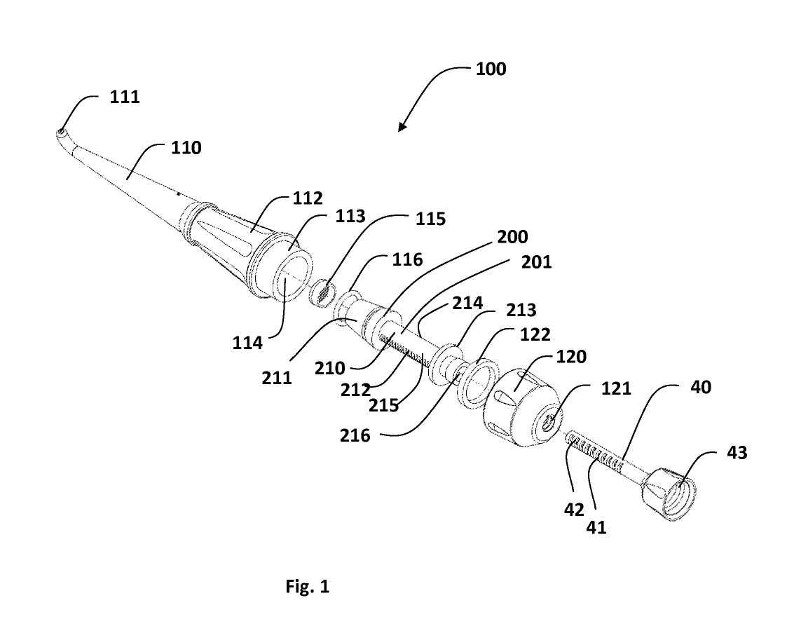

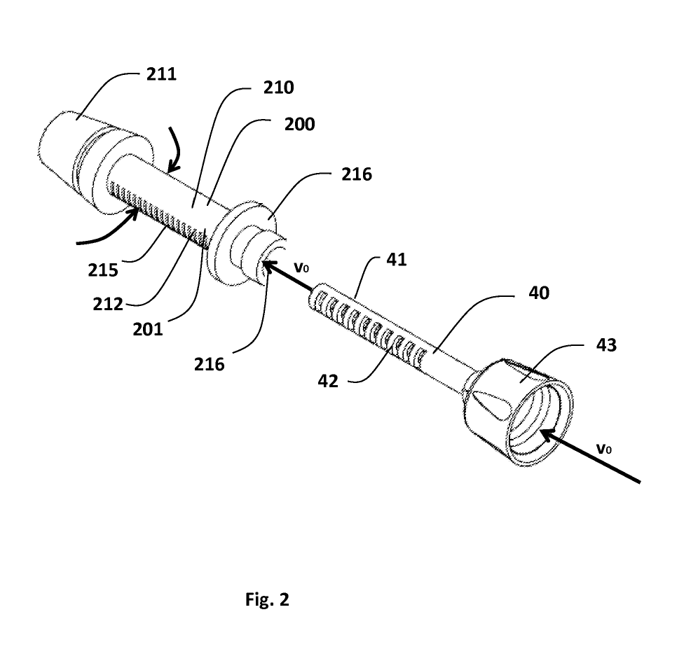

Reference is now made to FIGS. 1-2, schematically illustrating a dental applicator 200 for dispensing of dental material such as dental gel or paste through the operation of a dental water jet device 100 (also referred to as oral irrigator 100) in which it is configured to be installed, according to some embodiments of the present invention. According to these embodiments, the adaptor 200 can be marketed as a part of the water jet device 100 or as a separate part that can be installed in the water jet device 100. According to some embodiments, the water jet device 100 is a dental oral irrigator enabling to output pulsed and/or continuous water jets through each irrigation-session.

As illustrated in FIG. 1, the water jet device 100 includes a jet tip 110 that has a narrowing conical structure and an adaptor 120 for connecting the jet tip 110 to a water pipe (not shown) which can connect to a water container and/or to a water faucet for inserting water therein. The conical shape of the jet tip 110 allows increasing the jet pressure to be outputted through an outlet section 111 of the jet tip 110 since the an inlet section 113 of the jet tip 110 connecting to the adaptor 120 has an aperture diameter that is substantially larger than the diameter of the outlet section 111. The inlet section 113 of the jet tip 110 includes a base section 112 configured to receive therein the applicator 200 or a part thereof.

According to some embodiments of the present invention, as illustrated in FIGS. 1-2, the applicator 200 includes a dispensing member 210 having a cannular member 215 having one or more array of openings 212, creating a tube like shape opened at its ends and having the cavity therein, a first rim 211 and a second rim 213 that protrude from an outer surface of the cannular member 215 forming a recess 201 of this outer surface, for creating a space defined by the recess 201 created to allow forcing a material that is located within the recess 201 to be forced through the of openings 212 into the cavity 216 of the cannular member 215 to enable dispensing allotted portions of the material through the cavity 216 during the water jet flow through a water trajectory “V₀”, defining the direction of the water jet when passing through the device 100 (see FIG. 2) and cannular member 215 inner cavity 216. The first rim 211 is configured to face and be inserted through the inlet section 113 of the jet tip 110 and the second rim 213 is configured to face and connect to the adaptor 120. In this way the applicator 200 can be installed in the water jet device 100 by inserting it into the cylindrical cavity of the base section 112, which is configured to encapsulate the applicator 200 therein.

According to some embodiments of the present invention, as illustrated in FIGS. 1-2, once the water jet is applied, it flows through the cavity 216 of the applicator 200 and some of the water is forced out of the openings 212 towards the space (recess 201) where the material is located between the outer walls of the cannular member 215 and the inner walls 114 of the jet tip 110. The exiting water (that exited through the openings 212) mix with some of the material (e.g. gel) located in this recess 201 that is closed by the inner walls 114 of the jet tip 110 and takes a portion of the material (e.g. gel/paste) back into the cavity 216 of the cannular member 215 into the water stream running therethrough, thereby allowing dispensing water mixed with portions of the material through the jet tip 110 for applying the material along with the pressured water jet over the oral area to which it is directed (e.g. the gum-line in case of dental materials or the tooth itself for cosmetic materials such as blotching materials etc.). This allows dispensing the water jet along with the material for improving the dental/cleansing/cosmetic operation of the material over the oral area as well as allows dispensing the material in an allotted and economic manner.

The applicator 200 first rim 211 is slightly coned enabling fitting a designated water filter 115 to connect thereto through an O-ring 116. The cannular member 215 of the gel dispensing member 210 has a smaller diameter then that of its rims 211 and 213 to allow this section to be walled by the inner wall 114 of the base section 112 creating a space therebetween. In this configuration, when the material dispensing member 210 is inserted through the jet tip 110 the user may be able to force material through the second rim 213 to the space between the walls 114 of the base section 112 and the cannular member 215 by, for example using a removable applying member 40. To allow the user to easily fill the space between the applicator 200 and the inner wall 114 of the jet tip 110. The applying member 40 may include an elongated member 41 having at least one array of openings 42 positioned to fit the applicator's 200 array(s) of openings 212, where the elongated member 41 is sealed at its distal edge that is configured to be inserted into the inner cavity 216 of the applicator 200; and a connector 43 for connecting the applying member 40 to a pressable container such as a tube container of a dental cleansing material materials such as Chlorhexidine gel, tooth gel or paste and the like. Once the applying member 40 is connected to the tube container (e.g. through screwing threaded at its edge suitable for a standard male screw thread of typical material tube containers) the user can press the tube to force the material into the inner cavity 216 of the applicator 200 through the elongated member's 41 openings 42. The material will further be forced from the inner cavity 216 to the space between the jet tip 110 inner wall 114 and the cannular member 215 recess 201 surface through its openings 212. Once this space is filled (can be felt by the back pressure applied upon the tube container when the user continues pressing thereof), the applying member 40 can be removed and to connect the water jet device 100 to water supply through a water pipe (e.g. to a water container, which is a part of the water jet device or to a water faucet).

As illustrated in FIG. 1, the connector 120 has a back rim 121 that is of a diameter that is compatible to the outer diameter of the elongated member 41—both can be adapted to a water pipe standard diameter (e.g. standard dimensions thereof). The connector 120 can connect to the rear second rim 213 of the material dispensing member 210 through an O-ring 122.

According to these embodiments, once the material is inside the space between the inner wall 114 and the cannular member 215 and once the water jet device is assembled, connected to the water supply and operated, the water jet goes along the V₀ trajectory through the inner cavity 216 of the cannular member 215 towards the outlet section 111 of the jet tip 110, some of the material returns through the openings 212 to the cavity 216 and is carried by the water jet outwardly towards the area the user is directing the outlet section 111. The space dimensions and volume may be designed to allow encapsulating enough material therein to allow using the amount of material filling this space for multiple irrigation session. The volume of this space (determined by the diameter and length of the inlet section 113 and base section 112 and the diameter and length of the cannular member 215) as well as the number, locations and size of the openings 212 should be designed/configured according to the type of water jet device 100 (e.g. dental or other and/or the jet pressure and type i.e. pulsed or continuous), the material types that it should dispense and their viscosity level, and the like, to allow optimal economical and efficient material dispensing.

For example, in case of an oral irrigator water jet device 100 the user is recommended to direct the outlet 111 to the gum-line area and therefore this method and device 100 allows inserting reasonable allotted portions of material through the water jet pressure through the gum-line into areas between the teeth and gums thereby allowing the material to adhere to the tooth in gum-covered areas by using the jet force that slightly separates the gums from the tooth in these area. This dramatically improves oral hygiene and can even help preventing surgery in some case since the material is actually forced to adhere to tooth surfaces otherwise inaccessible. If the material was merely rubbed over the gum-line before using the water jet rather than applied during the applying of the water jet as a part of the jet itself, most of the material was washed away by the water material wasting a major percentage thereof enabling only a very small portion to actually adhere to the covered teeth surfaces underneath the gum-line. The current configuration, method and applicator 200 allow much greater quantities of material to adhere to the covered teeth surfaces while using much less material in each irrigation-session.

As illustrated in FIG. 1, the jet tip 110 edge may be bent so that the outlet section 111 is angular to the rest of the jet tip 110 body to allow easy access to oral areas in case of a dental water jet device 100 or to any other area the water jet should reach. In this case the water pipe can be flexible to allow the user to easily move and twist the jet tip 110 to access different locations in his/her oral cavity.

According to some embodiments of the present invention, the water jet device may further include a control button or valve conveniently located over the jet tip 110 for enabling the user to easily open and close water flow thereto.

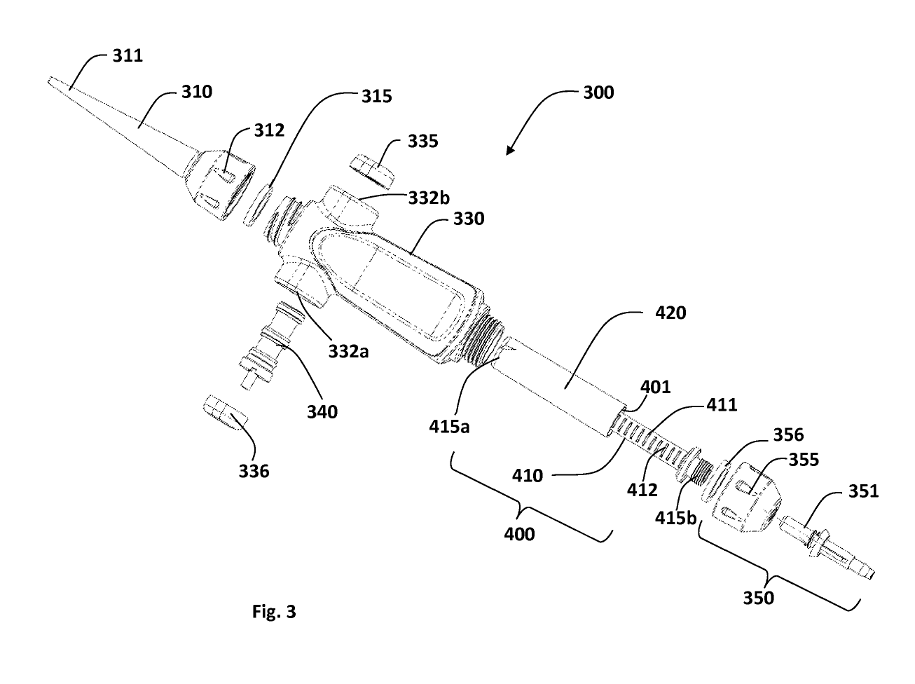

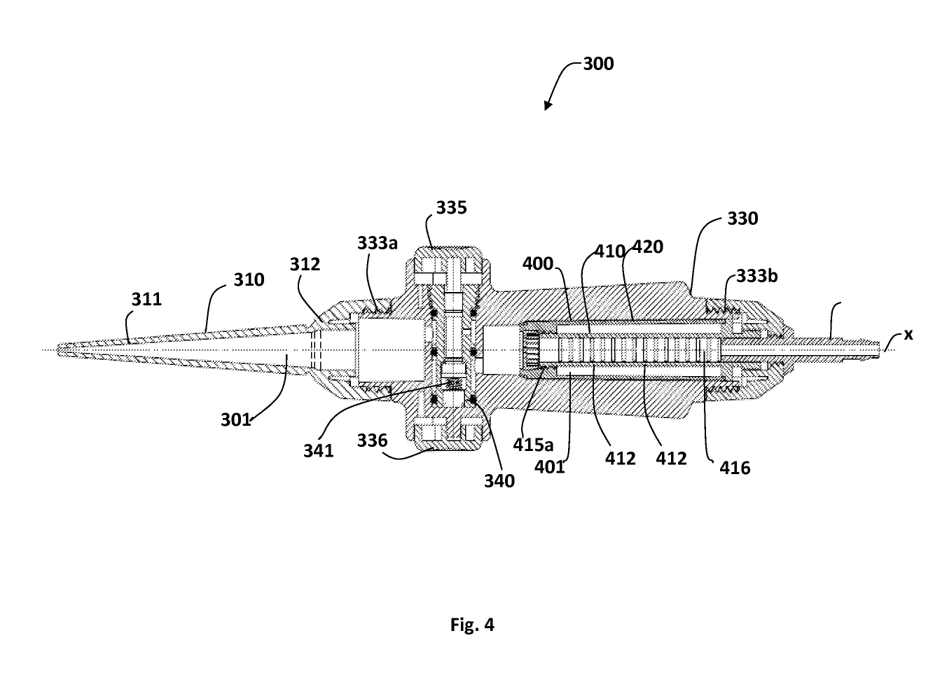

Reference is now made to FIGS. 3-4, schematically illustrating a dental water jet device 300 with a replaceable (dispensable) and/or refillable applicator 400, according to other embodiments of the present invention. In these embodiments, the water jet device 300 includes: (i) a straight (unbent) jet tip 310 including an outlet section 311 and a connector inlet section 312; (ii) a handle 330 with a valve mechanism 340; (iii) the dispensable applicator 400; and (iv) a connector 350 for connecting the water jet device 300 to water supply (such as a water container or a water faucet) via a water pipe (Not Shown).

As illustrated in FIGS. 3-4, the connector 350 includes an adaptor 320 that allows connecting to the handle 330 (e.g. through screw based connection and through a water sealing O-ring 322) and to the second rim 415 of the applicator 400 at one end, and to a water pipe (Not Shown) at its other end through a pipe connecting adaptor 351.

According to some embodiments of the present invention, as illustrated in FIG. 3, the valve mechanism 340 located at the handle 330 of the water jet device 300, is designed to allow a user to easily open and close the water jet by including a valve therein that can be open and closed via a press button 336. In this example, to open the water jet the user is required to press the elongated valve mechanism 340 button 336 connected to a first side 332a of the body of the handle 330, which ultimately opens a sealer valve therein (e.g. via a spring 341 based release mechanism) to allow water flow and release the pressure or even completely let go of the valve mechanism 340 portion to close the water jet, whereby the sealer valve simply returns to its place (closed position in which water is sealed from entering the water jet device 300) through the spring 341 release in which it seals water passage towards the jet tip 310. The valve mechanism 340 may further allow controlling the water flow and not just open and close thereof by controlling an aperture of an opening of the sealer valve therein by controlling pressure applied to compress a coiled spring connected thereto, for example. The handle 330 other second side 332b may be sealed as well by a cover 335.

The applicator 400 includes (i) a dispensing member 410 including a dispensing portion 411 having multiple openings 412, a first rime portion 415a and a second rim portion 415b; and (ii) a cover 420. According to some embodiments, as illustrated in FIG. 3, the cover 420 envelopes and walls the dispensing portion 411 of the dispensing member 410 such that it seals it while creating a space 401 between the cover's 420 wall and the cannular member 411 into which the applicator can be forced through the plurality of opening when filling/refilling the applicator 400. According to some embodiments, as illustrated in FIG. 3, the cover 420 is made from transparent rigid material to allow a user to see the remaining applicator inside the applicator's space 401 to know if the applicator 400 should be replaced or refilled.

According to some embodiments of the present invention, the applicator 400 may be filled having the space 401 between its transparent cover 420 and dispensing member 410 already filled with applicator, while the openings of the rims 415a and 415b of the dispensing member 410 are sealed by removable sealers to allow the user to install the applicator 400 in the water jet device 300 by removing the sealers and inserting the applicator 400 into the handle 330 of the water jet device 300 and then connecting the handle 330 to the connector 350 for closing the water jet device 300. Since the cover 420 is transparent, the user can see when the applicator 400 needs refilling or replacing. In cases in which the applicators are marketed as dispensable applicators—the removable sealers may be designed so as not to allow resealing the rims 415a and/or 415b of the dispensing member 410. In other cases the applicator 400 includes sealers that can be reused to seal the rims 415a and 415b to refill the applicator 400 by using a material applying member that is similar in concept to the one described in relation to FIGS. 1-2, using a container tube connected thereto to allow filling the applicator 400 by squeezing/pressing the container tube to force the material therefrom into a cavity 416 of the dispensing member 410 and therefore to force the material to the space 401 between the dispensing member 410 and the cover 420 through the openings 412 of the dispensing member 410.

Due to the structure of the applicator 410, once the water jet is applied through the applicator cavity 416 when directed through the first rim 415a towards the jet tip 310 outlet portion 311 to exit the water jet device 300 it carries allotted portions of the material that enter the cavity 416 and join the water jet to allow the material portion to be applied over the oral area along with the water jet flowing through this cavity 416.

The water jet devices such as 100 and 300 described in respect to some specific embodiments referring to oral irrigators can simply be used to describe other types of water jet devices using other types of materials depending on the purpose of the water jet device and/or its design.

The cross sectional view of FIG. 4 shows how the water jet is directed through an inner cavity 301 of the water jet device 300 and through the cavity 416 of the applicator 400 substantially along a main axis “x” of the device 300 and applicator 400. portions of the of the water jet directed through axis “x” enter the space 401 between the outer surface of the dispensing portion 411 and the inner wall of the cover 420 where the material (e.g. dental gel material) is located, through the openings 412 of the applicator's 400 dispensing portion 411. The water then return to the inner cavity 416 while taking a portion of this material there with while continuing towards the opening portion 311 of the water jet device 300 for ejecting therefrom. This way portions of the material are being dispensed from the water jet device 300 and applicator 400 installed therein whenever the water jet is applied through the device 300.

According to some embodiments of the present invention, the water jet device may also include a control unit that can electronically control mechanical and/or other functions of the water jet device and/or the applicator. For example, to control the valve mechanism or to notify the user (e.g. through visual and/or auditory alarms) that the material in the applicator is about to run out. To allow such indication, some mechanism that senses the amount of material in the space between the dispensing member and the wall surrounding it creating the space for the material to be stored in (either the inner wall of the jet base section or of the transparent cover of the applicator itself, depending on the specific embodiment) such as an optical sensor. Once the sensor identifies that the applicator is “empty” it operates a visual/auditory alarm signaling to the user that the applicator should be refilled/replaced.

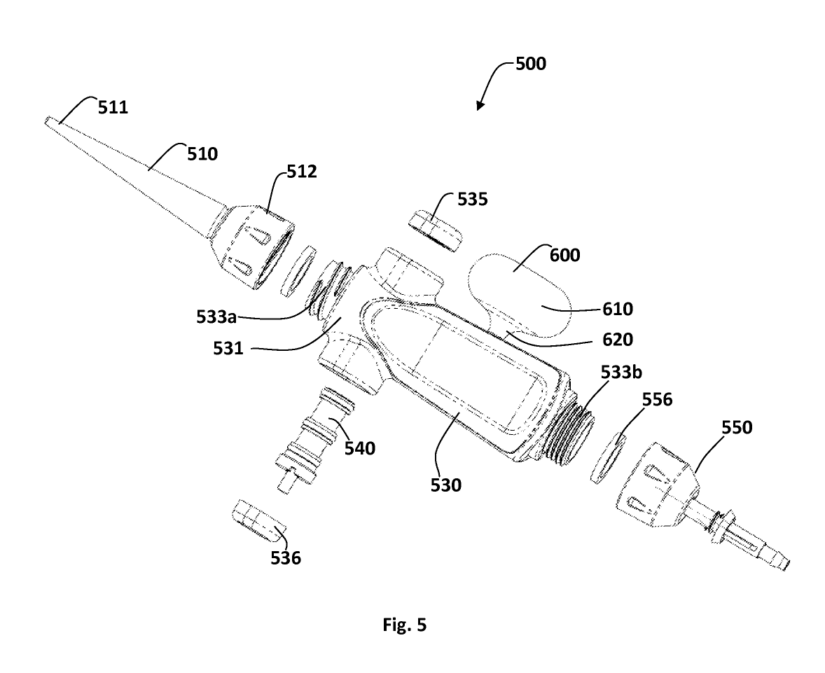

Reference is now made to FIG. 5, schematically illustrating a water jet device 500 with an external applicator 600, according to other embodiments of the present invention. In these embodiments, the water jet device 500 includes: (1) a body having (i) a jet tip 510 having an outlet section 511 and a connector inlet section 512; (ii) a handle 530 with a valve mechanism 540; (iii) and (iv) a connector 550 for connecting the water jet device 500 to water supply (such as a water container or a water faucet) via a water pipe (Not Shown); and (2) the applicator 600. Other components of the water jet device 500 are similarly configured to equivalent components of the water jet devices 300 and 100 as described above; such as a cover 535, a press button 536 of the valve 540 and a connector 550 for connecting the water jet device 500 to water supply via an O-ring 556.

According to some embodiments of the invention, the applicator 600 includes an external container 610 having a funnel shaped edge 620 for connecting to an inner cavity tube of the water jet device 500 through which the water jet passes. The container 610 is filled with material such as a dental cleansing gel allowing allocated dispensing of the material into the water jet. The container 610 externally connects to the water jet device 500 body through an opening in the water jet device 500 configured for connecting to the edge 620 thereof, for allowing easy replacement and/or refilling thereof.

The narrowing end of the funnel shaped edge 620 of the container 610 connecting into the water jet creates a suction pressure that draws water from the water jet into the container 610. The drawn water return into the jet while bringing some of the material in the container 610 into the water jet therewith at each operation of the water jet device 500 allowing thereby to dispense allocated portions of the contained material upon each utilization of the water jet device 500.

According to some embodiments, the applicator 600 is removably connected to the water jet device 500 body for allowing replacing and/or refilling thereof.

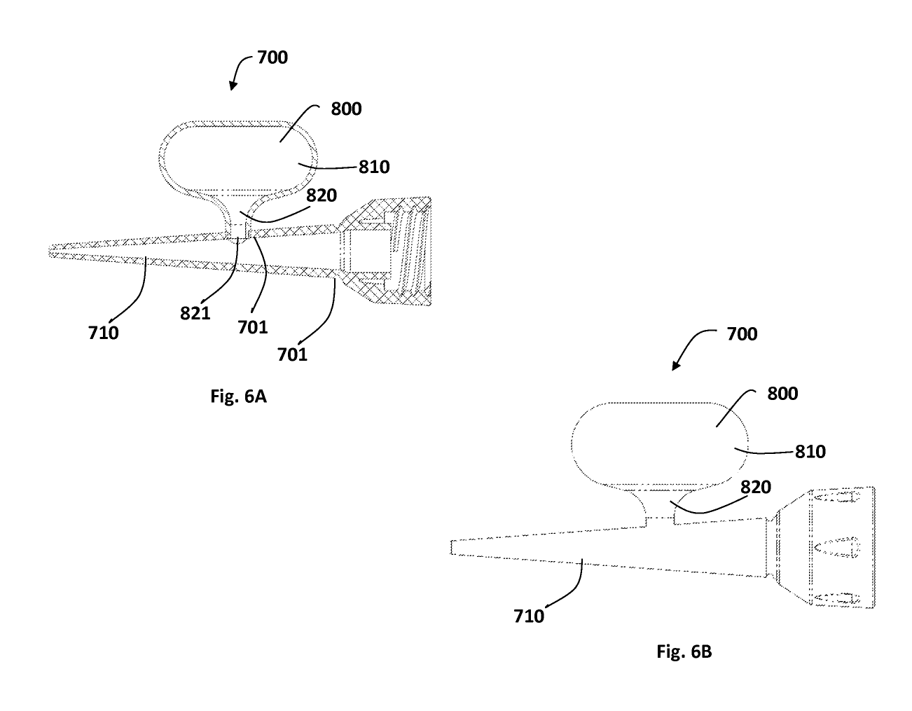

FIGS. 6A and 6B illustrate another embodiment of a water jet device 700 having the same configuration of an applicator 800 having a container 810 and a narrowing edge 820 connected to the jet tip 710 of the device 700 for allowing dispensing allocated portion of a material contained therein into the water jet through an inner cavity through which the water jet passes, according to other embodiments of the invention.

The funnel shaped edge 820 of the applicator 800 includes an opening 821 which connects to a designated opening 702 at the water jet device 700 (in this case the opening 702 is in the jet tip 710). The applicator 800 may include a connecting edge 820 configured for fastening to the water jet device 700 in a sealed manner.

Optionally, the container 820/620 is made from a flexible material allowing creating vacuum or partial vacuum therein once the water jet device 700/500 is operated.

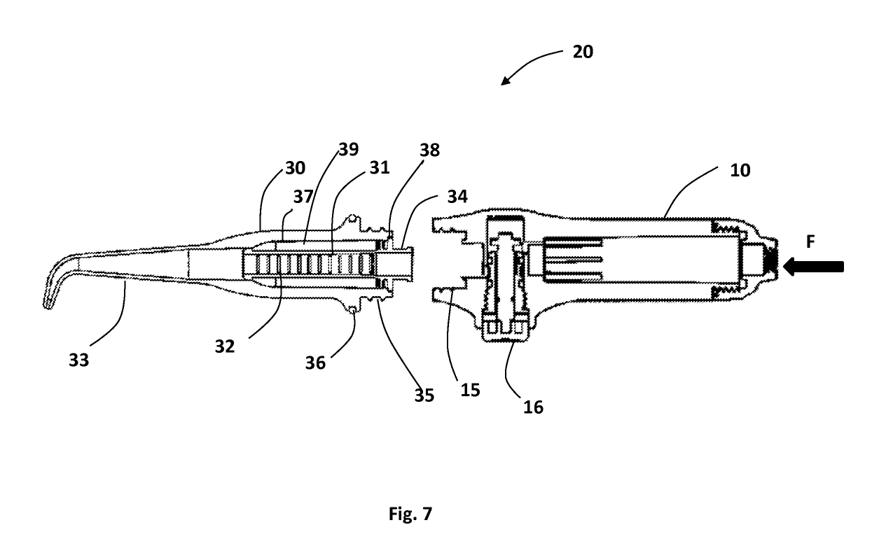

Reference is now made to FIG. 7 showing an applicator 30 having a dispensing member 31 configured for serving as a removable and optionally dispensable water tip 33 of a water jet device 20 from which water jet exits, according to other embodiments of the invention. The applicator 30 is configured for being removably secured to a body 10 of the jet device 20 such as to enable the water jet to be directed therethrough from the rear end of the body 10 to the front edge opening of the dispensable tip 33 illustrated by an arrow indicating the F direction of jet flow. The jet tip 33 is actually also serving as the cover of the dispensing member 31 as well as a narrowing tip of the water jet device 20 once secured to the body 10 thereof.

According to some embodiments, as shown in FIG. 7, the dispensing member 31 is actually embedded as part of the jet tip 33, and therefore the applicator 30 itself is an improved dispensing jet tip. The jet tip 33 in which the dispensing member 31 is embedded can be of any desired structural configuration such as the one shown in FIG. 7 having a conical portion connected to a bent other conical tip.

According to some embodiments of the invention, as shown in FIG. 7, the dispensing member 31 has multiple openings 32 thereover and is hollowed such as to create a cavity therein through which the jet of water is directed. The configuration of the dispensing member 31 in respect to the inner side of the jet tip 33 is such that a space 39 is formed between the inner walls 37 of the jet tip 33 and the outer walls of the dispensing member 31. The dispensing material is placed in this space 39 to allow allotted dispensing thereof during water jet passage through the dispensing member 31 cavity, in a similar manner in respect to the dispensing mechanism and principles discussed above.

As shown in FIG. 7, the distal (rear) edge of the applicator 30 has an external screw thread 35 configured for being secured to an inner screw thread 15 of the jet device body 10 for securing the applicator 30 to the body 10 in a water proof manner allowing the waster jet to only pass through the dispensing device 31 when directed towards the opening of the jet tip 33. An O-ring 36 can further ensure such tight and water proof securing. To body 10 of the jet device 20 may further include a valve operable via a press button 16 for enabling and disabling water jet flow and optionally also for controlling water flow rate.

Additional or alternative mechanisms can be used for removably securing the applicator 30 to the body 10 such as snap fastening mechanism and the like.

The applicator 30 can be easily removed from the body 10 for replacing or refilling thereof enabling marketing the applicator jet tip 30 as a dispensable piece for having the customer using the same water jet device body 10 by connecting it to the water tap or an extension pipe connected thereto and easily replacing the jet tip applicator 30 when the dispensing material runs out. Another one or more removable jet tips can be used that do not have a dispensing member therein to allow using the water jet device without dispensing the material therefrom and only installing the dispensing applicator when the user wishes to have the jet device dispense the allotted portions of the dispensing material along with the water.

According to some embodiments, the dispensing member 31 is fastened to the cover tip 33 via a snap mechanism 39.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. An applicator for dispensing materials through a water jet device, said applicator comprising:
a) a dispensing member having an inner cavity therein, said dispensing member comprises a plurality of openings thereover for allowing water and dispensing materials to enter and exit said cavity; and
b) a cover covering said dispensing member in such a manner that it forms a space between said cover and said dispensing member in the area of the openings of said dispensing member for containing a dispensing material therein, said cover is configured as a tip of the water jet device,
wherein said applicator is configured for connecting to the water jet device such as to have water jet thereof directed through said cavity of said dispensing member,
wherein the dispensing material in said space is dispensable through said plurality of openings from said space and into said cavity of said dispensing member such that once a water jet is directed by said water jet device through said cavity of said dispensing member, a portion of the water jet enters said space through said openings and carries along into said cavity allotted portions of the dispensing material during the water jet flow through said cavity, and
wherein said applicator is configured for removably connecting to the water jet device as the tip of the water jet device, for replacing and/or refilling thereof.

2. The applicator according to claim 1, wherein said cover being configured as the tip of the water jet device, has a first edge that has a narrowing shape for enabling water jet with allotted portions of dispensing material exit therefrom and a second edge that is connectable to a body of the water jet device, said cover is further configured for having said dispensing member inserted therein such that an inner wall of said cover covers said dispensing member to form said space therebetween in which the dispensing material is located.

3. The applicator according to claim 1 is configured to removably connect to a body of said water jet device through a connector and an adaptor thereof.

4. The applicator according to claim 1 further comprising a removable gel applying member including an elongated member having a plurality of openings thereover, wherein a frontal edge thereof is sealed, said elongated member is configured to be inserted through the applicator's inner cavity, said gel applying member is further configured to connect to a pressable gel container for enabling to insert the gel into said applicator through said elongated member, wherein said sealed edge also seals said first rime of the applicator and thereby forces the pressed gel only through the openings of both said elongated member and said cannular member.

5. The applicator according to claim 1, wherein said dispensing material is at least one of: medical material, cosmetic material, cleansing material.

6. The applicator according to claim 1, wherein said dispensing material is in the form of gel, paste, or powder.

7. The applicator according to claim 1, wherein said dispensing member has a cannular member over which said openings are disposed, said cannular member edges having rims configured for engaging rims of said cover such as to form the space between said cover and said cannular member for containing the dispensing material therein.

8. A water jet device for enabling dispensing materials when using thereof, said water jet device comprising:
a jet device body;
a connector for connecting said body to a water pipe for receiving water therethrough; and
an applicator for economically dispensing of a material therethrough when the water jet is operated, said applicator being configured as a removable and replaceable tip of the body and of the entire water jet device,
wherein said applicator comprises:
a) a dispensing member comprising a cannular member having an inner cavity therein, and at least one rim connected to said cannular member and protruding therefrom forming a recess thereby over an outer surface of said cannular member, said cannular member comprises a plurality of openings thereover; and
b) a cover having a tip shape covering said cannular member in such a manner that it encloses the recess to form a space between said cover and said cannular member in which the material is located,
wherein said space is configured for containing a dispensing material therein to allow dispending the contained material through said plurality of openings into said cavity of said cannular member to enable dispensing allotted portions of the material when a respective water jet is directed towards a respective jet tip of said water jet device during the water jet flow through said cavity, and
wherein said applicator is configured for removably connecting to the water jet device for allowing replacing and/or refilling thereof and for allowing using said water jet device without said applicator.

9. The water jet device according to claim 8, wherein said cover of said applicator being configured as the tip of the water jet device, has a first edge that has a narrowing shape for enabling water jet with allotted portions of dispensing material exit therefrom and a second edge that is connectable to a body of the water jet device, said cover is further configured for having said dispensing member inserted therein such that an inner wall of said cover covers said dispensing member to form said space therebetween in which the dispensing material is located.

10. The water jet device according to claim 8 is a dental water jet device functioning as an improved oral irrigator device, allowing applying dental materials.

11. The water jet device according to claim 8 further comprising a valve installed at the jet tip to allow users to open and close the water jet therethrough.

12. The water jet device according to claim 8, wherein said base member is a narrowing tube shape, where its inner wall enables walling said applicator to form the cover in such a manner that creates a space between said cannular member and said wall into which the gel is forced through the plurality of openings, wherein once the water jet is applied through the applicator cavity when directed through the first rim towards the jet tip to exit the water jet device carry allotted portions of the gel inserted to the water jet from said space and into said cavity.

13. The water jet device according to claim 8, wherein said cover optionally has a curved shape at an outlet edge thereof.

14. The water jet device according to claim 8 further comprising a handle designed for a user to grab on thereto when applying a water jet, said handle comprises a valve mechanism for enabling the respective user to control water flow while holding said handle.

15. The water jet device according to claim 8, wherein said material is at least one of: medical material, cleansing material, cosmetic material.

16. The water jet device according to claim 15, wherein said material is in the form of gel, paste, cream or powder.
